(19) United States
(12) Patent Application Publication
(10) Pub. No.: US 2018/0333597 A1
(43) Pub. Date: Nov. 22, 2018

(54) HIGH-RISE BUILDING EVACUATION KIT

(71) Applicant: Carole May Brosso, Reisterstown, MD (US)

(72) Inventor: Carole May Brosso, Reisterstown, MD (US)

(21) Appl. No.: 15/816,375

(22) Filed: Nov. 17, 2017

Related U.S. Application Data
(60) Provisional application No. 62/508,412, filed on May 19, 2017.

(51) Int. Cl. A62B 3/00; B64D 17/30; B64D 17/40

(52) U.S. Cl. CPC A62B 3/00; G01S 19/13; B64D 17/40; B64D 17/30

(57) ABSTRACT

A high-rise building fire safety and evacuation kit. The kit includes a container having an inner surface, an outer surface, and a closure operable to close and open an opening leading into the container. The kit further includes a glider disposed within the container. The glider includes a harness configured to secure to a torso and legs of a user, lines connected to the harness and a canopy connected to the lines. The kit further includes a glass breaker. The glass breaker includes a handle and a sharp pointed metal tip configured to break glass. The kit further includes wearable fire gear, flashlight on lanyard and nourishments. The evacuation kit is linked via a GPS beacon to an emergency response team for monitoring.

### CROSS-REFERENCE TO RELATED APPLICATION

This application claims the benefit of priority of U.S. provisional application No. 62/508,412, filed May 19, 2017, the contents of which are herein incorporated by reference.

### BACKGROUND OF THE INVENTION

The present invention relates to high-rise building fires and collapsing structures and, more particularly, to a high-rise building evacuation kit.

High-rise buildings that catch on fire usually become electrically disabled which shuts down the elevators. Further, those on higher floors may be stuck in the building because the stairwells are blocked, consumed by fire or filled with smoke. In the event of a building having the potential to collapse, the need to evacuate becomes urgent.

As can be seen, there is a need for a fire survival and evacuation kit used in high-rise buildings.

### SUMMARY OF THE INVENTION

In one aspect of the present invention, a high-rise evacuation kit comprises: a container comprising an inner surface, an outer surface, and a closure operable to close and open an opening leading into the container; a glider disposed within the container, the glider comprising a harness configured to secure to a torso of a user, lines connected to the harness and a canopy connected to the lines; a glass breaker comprising a handle and a sharp pointed metal tip configured to break glass.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention; and

FIG. 2 is a rear perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a survival satchel to ultimately save a distressed life from a burning or collapsing high-rise building. The kit of the present invention creates the opportunity for the trapped person in a high-rise building to jump to safety, using the low distance para-glider or parachute. The kit of the present invention may further allow the person to cover themselves with fire resistant gloves, mask, and a poncho, if there is a way to exit via stairwell. The kit may further include a glass breaking axe-hammer, which allows the user to break a window and jump to safety. The kit of the present invention may further include a hand-cranking flashlight on a luminescent lanyard. In certain embodiments, the kit may include a beacon system that sends a distress signal to a local police or fire department. In certain embodiments, a harness attached to the para-glider or parachute may include an additional safety strap or harness for children. Food, such as and energy bar, and water may be stored in the kit.

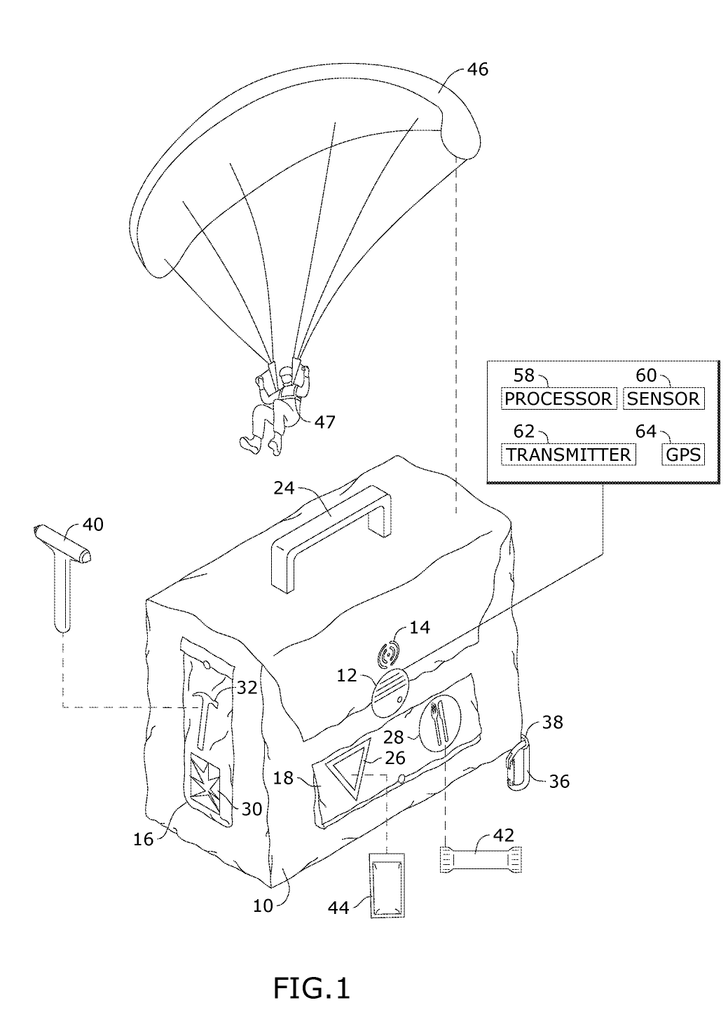

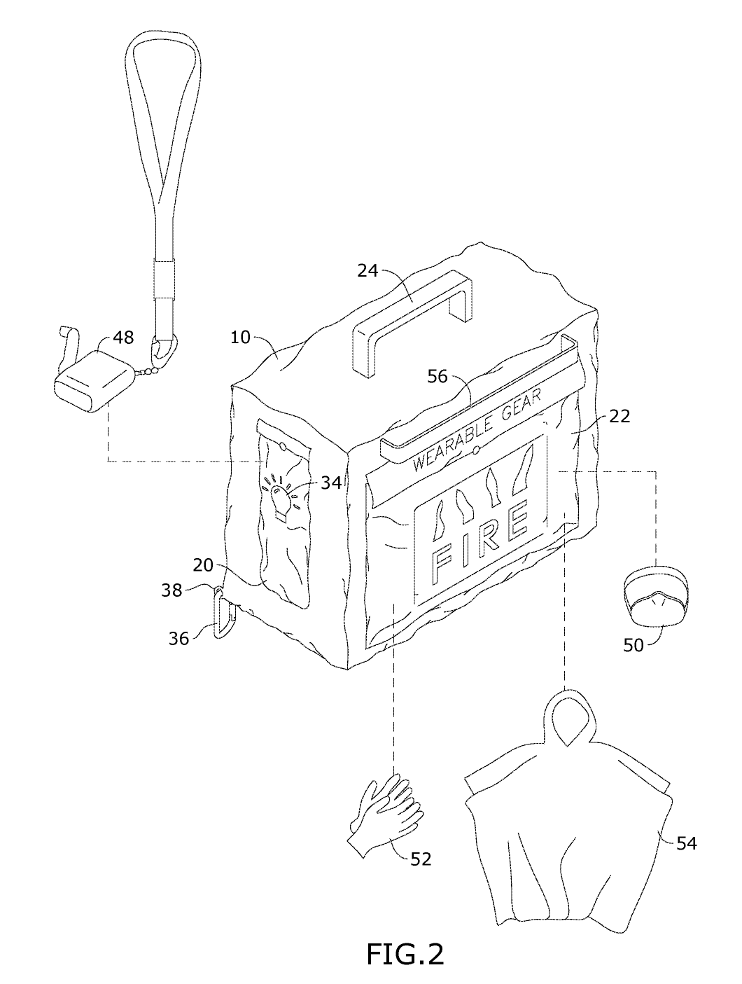

Referring to FIGS. 1 and 2, the present invention includes a high-rise building evacuation kit. The kit includes a container 10 made of a fire-resistant material. The container 10 has an inner surface, an outer surface, and a closure operable to close and open an opening leading into the container 10. The kit further includes a glider 46, such as a parachute or a low distance para-glider disposed within the container 10. The glider 46 includes a harness 47 configured to secure to a torso and legs of a user, lines connected to the harness and a canopy connected to the lines. The kit further includes a glass breaker 40. The glass breaker 40 includes a handle and a sharp pointed metal tip configured to break glass.

The container 10 of the present invention may be a bag, satchel and the like. The closure may be a flap that folds over an opening of the container 10. A clamp, clasp, hook and loop fastener, buckle and the like may secure the closure in a closed position. The container 10 of the present invention further includes a top, a bottom, a right side, a left side, a front side, and a rear side. The container 10 may include a U-shaped handle 24 secured to the outer surface on the top. The container 10 may further include an elongated U-shaped bracket 56 secured to the outer surface at the rear side. The bracket 56 is used to secure the container 10 to a fixed surface, such as a wall, a desk and the like. In certain embodiments, a snap hook 36, such as a carabiner, is connected to a corner of the outer surface of the container by a looped cord 38.

The container 10 may further include a first outer pocket 16 formed on the outer surface at the left side, a second outer pocket 18 formed on the outer surface at the front side, a third outer pocket 20 formed on the outer surface at the right side, and a fourth outer pocket 22 formed on the outer surface at the rear side. The glass breaker 40 may be disposed in the first outer pocket 16. A hammer design 32 and/or a broken glass design 30 may be printed on the first outer pocket 16 to indicate that the glass breaker 40 is disposed within the first outer pocket 16. Food 42 and water 44 may be disposed in the second outer pocket 18. A water symbol 26 and a food symbol 28 may be printed on the second outer pocket 18 to indicate that the food 42 and water 44 are disposed within the second outer pocket 18. A hand cranked flashlight 48 with a luminescent lanyard may be disposed in the third outer pocket 20. A light design 34 may be printed on the third outer pocket 20 to indicate that a flashlight is disposed within the third outer pocket 20. Fire retardant garments, such as masks 50, gloves 52 and a poncho 54, may be disposed in the fourth outer pocket 22. A text may be printed on the fourth outer pocket 22 to indicate that fire resistant garments are disposed within the fourth outer pocket 22.

The kit of the present invention may further include a beacon system 12. The beacon system 12 may be battery operated. The beacon system 12 may include a processor 58, a sensor 60 operable to detect when the closure is opened, a transmitter 62 operable to transmit a signal over a wireless communication network, and a global positioning system (GPS) 64 operable to determine a location of the container 10. When the closure is opened, the sensor 60 sends a signal to the processor 58 and the processor directs the transmitter 62 to send the signal over the wireless network to a third party with the location of the container 10. The third party may be an emergency response team, such as a police or fire department. A notification signal design 14 may be printed on the container to illustrate the beacon system 12.

It should be understood, of course, that the foregoing relates to exemplary embodiments of the invention and that modifications may be made without departing from the spirit and scope of the invention as set forth in the following claims.

What is claimed is:

1. A high-rise building evacuation kit comprising:
a container comprising an inner surface, an outer surface, and a closure operable to close and open an opening leading into the container;
a glider disposed within the container, the glider comprising a harness configured to secure to a torso of a user, lines connected to the harness and a canopy connected to the lines;
a glass breaker comprising a handle and a sharp pointed metal tip configured to break glass.

2. The high-rise building evacuation kit of claim 1, wherein the container further comprises a U-shaped handle secured to the outer surface.

3. The high-rise building evacuation kit of claim 1, further comprising a carabiner secured to the outer surface of the container by a looped cord.

4. The high-rise building evacuation kit of claim 1, wherein the container further comprises an outer pocket formed on the outer surface, wherein the glass breaker is disposed within the first outer pocket.

5. The high-rise building evacuation kit of claim 4, wherein the container further comprises a hammer design printed on the outer pocket.

6. The high-rise building evacuation kit of claim 1, further comprising a flashlight disposed within an outer pocket formed on the outer surface of the container.

7. The high-rise building evacuation kit of claim 6, wherein the container further comprises a light design printed on the outer pocket.

8. The high-rise building evacuation kit of claim 1, further comprising fire retardant garments disposed within an outer pocket formed on the outer surface of the container.

9. The high-rise building evacuation kit of claim 8, wherein the container further comprises a text printed on the outer pocket, the text indicating that garments are disposed within the outer pocket.

10. The high-rise building evacuation kit of claim 1, further comprising food and beverage disposed within an outer pocket formed on the outer surface of the container.

11. The high-rise building evacuation kit of claim 10, wherein the container further comprises a food and beverage design printed on the outer pocket.

12. The high-rise building evacuation kit of claim 1, further comprising a beacon system, the beacon system comprising:
a processor;
a sensor operable to detect when the closure is opened;
a transmitter operable to transmit a signal over a wireless communication network; and
a global positioning system operable to determine a location of the container, wherein the processor
directs the transmitter to send the signal over the wireless network to a third party with the location of the container when the sensor senses the closure is opened.
